(19) United States
(12) Patent Application Publication
(10) Pub. No.: US 2006/0198608 A1
(43) Pub. Date: Sep. 7, 2006

(54) Method and apparatus for coaching athletic teams

(76) Inventor: Frank D. Girardi, St. Pete Beach, FL (US)

Correspondence Address: LARSON AND LARSON, 11199 69TH STREET NORTH, LARGO, FL, 33773, US

(21) Appl. No.: 11/166,426

(22) Filed: Jun. 24, 2005

Related U.S. Application Data
(60) Provisional application No. 60/594,021, filed on Mar. 4, 2005.

(51) Int. Cl. H04N 7/00

(52) U.S. Cl. 386/95

(57) ABSTRACT

In a computer program, a video input file and data input is segmented into individual play records so that each individual play can be displayed and manipulated by a user interface. If the video input file is digital, time stamps within the input file are used to segment the input file into individual play video files. Speech input is used to control the computer program and enter statistical information.

### CROSS-REFERENCE TO RELATED APPLICATION

This application is related to U.S. patent application Ser. No 60/594,021, filed Mar. 4, 2005, the disclosure of which is hereby incorporated by reference.

### BACKGROUND OF THE INVENTION

1. Field of the Invention

This invention relates to the field of coaching athletic teams and more particularly to a system for decomposing a game into discrete plays and allowing for the analysis of such discrete plays.

2. Description of the Related Art

Many applications designed to coach athletic teams use speech recognition to control the application and enter play information. Furthermore, these applications often import video recordings of the individual plays within a game, whereas the play information augments video segments with annotations and searchable text so as to make the system, on a whole, more useful.

A speech recognition system analyzes a user's speech to determine what the user said. Some speech recognition systems are frame-based, in which a processor divides digitized speech into a series of digital frames, each of which corresponds to a small time increment of the digitized speech. Some speech recognition systems are continuous, in that they can recognize spoken words or phrases even if they are missing pauses between words. Discrete speech recognition systems recognize discrete words or phrases and require a pause after each discrete word or phrase. Due to their nature, continuous speech recognition systems typically have a higher error rate in comparison to discrete recognition systems due to complexities of recognizing continuous speech.

The speech processor determines what was said by finding acoustic models that best match the utterance, and identifying text that corresponds to those acoustic models. An acoustic model may correspond to a word, phrase or command from a vocabulary, placed in a context. For example, in a free format speech input, the words, “stop recording” have no context and are much more difficult to recognize than the same words in a command entry system, where, based on context, only a relatively limited set of commands are possible, “stop recording” being one of such. Therefore, the recognition engine is more accurate, in that it only need determine if something similar to “stop recording” was uttered. It is known to use speech recognition to populate data in a form as in U.S. Pat. No. 6,813,603 to Groner, et al, issued Nov. 2, 2004, which is hereby incorporated in its entirety by reference. In this, individual fields have associated predefined standard responses, for example, a certain field may allow “Yes”, “No” or “Maybe”. This patent does not provide for alternate ways of saying the same word. For example, if a possible entry for a given field is “28 toss” and “22 divide”, “twenty eight toss” or “twenty two divide” would not be recognized, whereas it may be more natural than saying “two” “eight” “toss” or “two” “two” “divide”. Also, in context-free speech recognition, saying “two eight” is often interpreted as “to” “ate”.

In a typical speech recognition system, a user speaks into a microphone connected to a computer. The computer then uses a context (e.g., what it expects the user might say) to perform speech recognition and determine what was said. There are times when a certain command or phrase can be stated in several ways. For example, when using speech input of a vocabulary that consists of numbers and names, a random use may say the numeric portion as a complete number such as “twenty two” or as a series of discrete digits such as “two-two”.

Many existing systems use a video input port to import video information about an athletic event. This information may be video footage of a game. Current technology requires that a data entry person view the footage as it is being imported or after it is imported, and mark the start and end of each individual play. For example, if a football game is the event, to conserve tape, the recording is usually started before each play and stopped after each play, but all plays are recorded continuously, so a data entry person must watch the entire game, entering markers when each play starts and stops, and (possibly later), entering information about each play.

What is needed is a system that will respond to natural language spoken commands and provide an analysis of discrete plays within an athletic event and will import and separate a video recording of the event into individual plays.

### SUMMARY OF THE INVENTION

In one embodiment, a play analysis computer program for use in conjunction with a computer system is disclosed including a playbook; an input module for accepting commands, statistics and data inputs; and a video input module for accepting a video input stream of an athletic event and separating the video input stream into play segments or individual plays, each of which represent an individual play of the athletic event. A user interface is provided for displaying the play segments and data relating to the play segments and there is a database for storing the play segments and the data relating to the play segments. The input module stores statistics regarding the play segments in the database.

In another embodiment, a method for analyzing individual plays of a game is disclosed including receiving a digital video stream containing a digital video representation of an athletic event then while more video data is present in the digital video stream: (a) reading a next time stamp from the digital video stream and storing it in a first register; (b) creating an individual play output file for a current play of the digital video stream; (c) reading a segment of video from the digital video stream; (d) writing the segment of video to the individual play output file; (e) reading another time stamp from the digital video stream and storing it in a second register; (f) if the first register differs from the second register by more than a time gap, copying the contents of the second register into the first register and repeating the above steps (b) through (f); and (g) copying the contents of the second register into the first register and repeating steps (c) through (g).

In another embodiment, a machine-readable storage having stored thereon a computer program having a plurality of code sections executable by a machine for causing the machine to perform the steps of receiving a digital video stream containing a digital video representation of an athletic event then while more video data is present in the digital video stream: (a) reading a next time stamp from the digital video stream and storing it in a first register; (b) creating an individual play output file for a current play of the digital video stream; (c) reading a segment of video from the digital video stream; (d) writing the segment of video to the individual play output file; (e) reading another time stamp from the digital video stream and storing it in a second register; (f) if the first register differs from the second register by more than a time gap, copying the contents of the second register into the first register and repeating the above steps (b) through (f); and (g) copying the contents of the second register into the first register and repeating steps (c) through (g).

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a system of a first embodiment of the present invention during input of play information.

FIG. 2 illustrates a schematic view of the system of the first embodiment of the present invention during access of play information.

FIG. 3 illustrates a functional view of individual play record creation of the first embodiment of the present invention.

FIG. 4 illustrates a functional view of play record access of the first embodiment of the present invention.

FIG. 5 illustrates a flow chart of the record creation using time stamps to separate individual play segments from a digital video stream of the first embodiment of the present invention.

FIG. 6 illustrates a typical digital video stream used to input play segments of an embodiment of the present invention.

FIG. 7 illustrates a typical user interface of an application of the present invention.

FIG. 8 illustrates a speech interface flow chart of an application of the present invention.

FIG. 9 illustrates a typical user interface of an application of the present invention.

FIG. 10 illustrates a typical user interface of an application of the present invention.

FIG. 11 illustrates a typical user interface of an application of the present invention.

FIG. 12 illustrates a schematic view of a computer system on which the present invention operates.

FIG. 13 illustrates a flow diagram of the video input module of the present invention.

FIG. 14 illustrates a typical user interface of an application of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

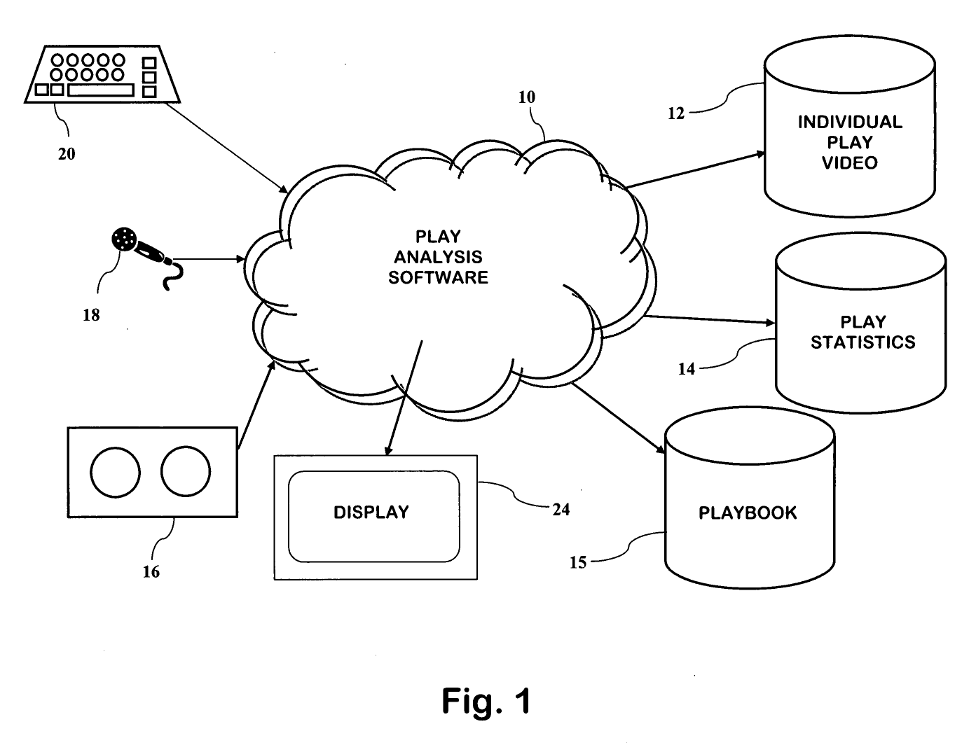

Referring to FIG. 1, a schematic view of a system of the present invention is shown. The play analysis software 10 accepts inputs from an input device such as a keyboard and mouse 20, a microphone 18 and a video source 16. The keyboard and mouse inputs 20 are used to control the program by entering or saying commands such as “start,” “stop,” or “show.” The keyboard and mouse inputs 20 are also used to enter information such as player names, play descriptions and results of a play. Being that a large amount of data is entered for each game, voice input through the microphone 18 is used in some embodiments to enter commands and statistics allowing for fast and accurate data entry. Before accepting voice inputs for such things as play names, a playbook 15 is created and populated with a vocabulary of expected play names, player names, etc. The playbook is populated by typing the information on the keyboard 20.

Athletic games are comprised of a series of individual plays. For example, a football game consists of many plays, each starting when the football is hiked and ending when a referee blows a whistle to indicate the end of play. A typical game may consist of hundreds of plays. To record a game, a videographer with a video camera will aim the camera at the focus of the play and start recording before the play begins and stop recording after the play ends. This creates a plurality of segments, each containing a video recording of an individual play on a video recording medium such as a video tape or video disk 16. The play analysis software 10 separates each individual play and stores it in an individual play database 12 for future retrieval. As each play is stored or at a later time, information about the play such as the play type, outcome and players involved is saved in a play statistics database 14. The play statistics are entered through the keyboard and mouse 20 and/or the voice input 18, consulting the playbook 15 for an accepted vocabulary of players, play names, etc. In some embodiments, the individual play video segments and play statistics are stored in one common database. Play video, statistics and status information are retrieved and displayed on a display 24.

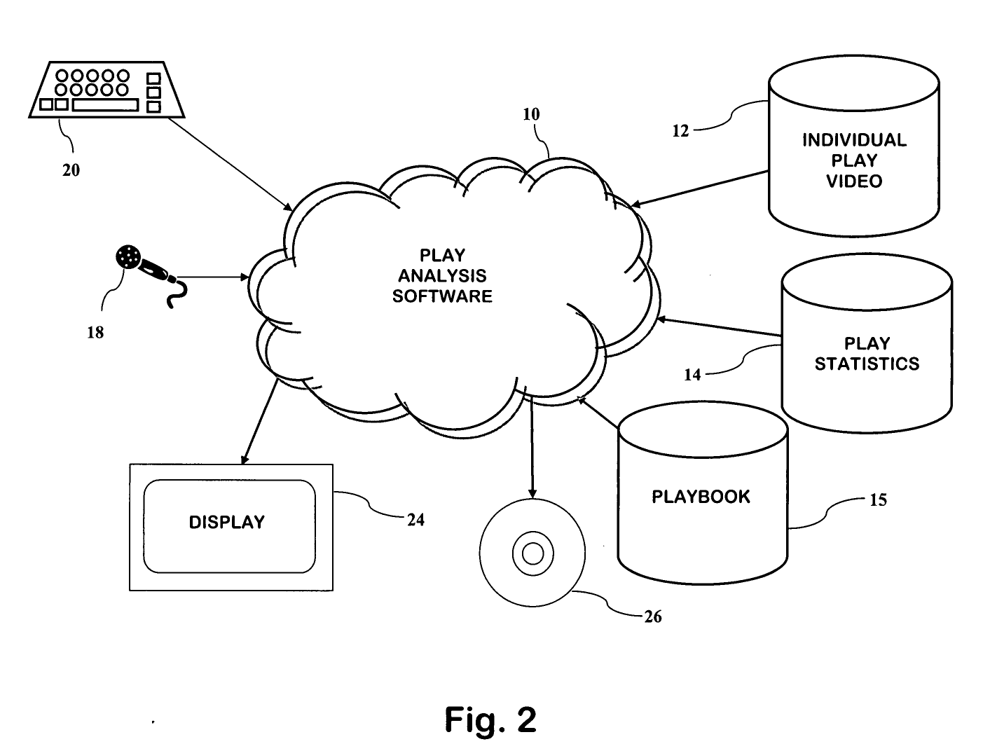

Referring now to FIG. 2, the operation of the system will be described during play analysis and output operations. The keyboard and mouse 20 and voice input 18 are used interactively with the display 24 to control and see play statistics and watch individual play video segments. Commands entered or said are interpreted by the play analysis software 10 and the appropriate play is accessed from the individual play video database 12 and play statistics database 14 and this information is displayed on the display 24 in a user interface. Alternately, one or more individual plays from the databases may be written to an output media 26 such as a CD, DVD disk or video cassette. For example, a series of plays in which an individual athlete is involved is written to a video cassette and sent to a college recruiter.

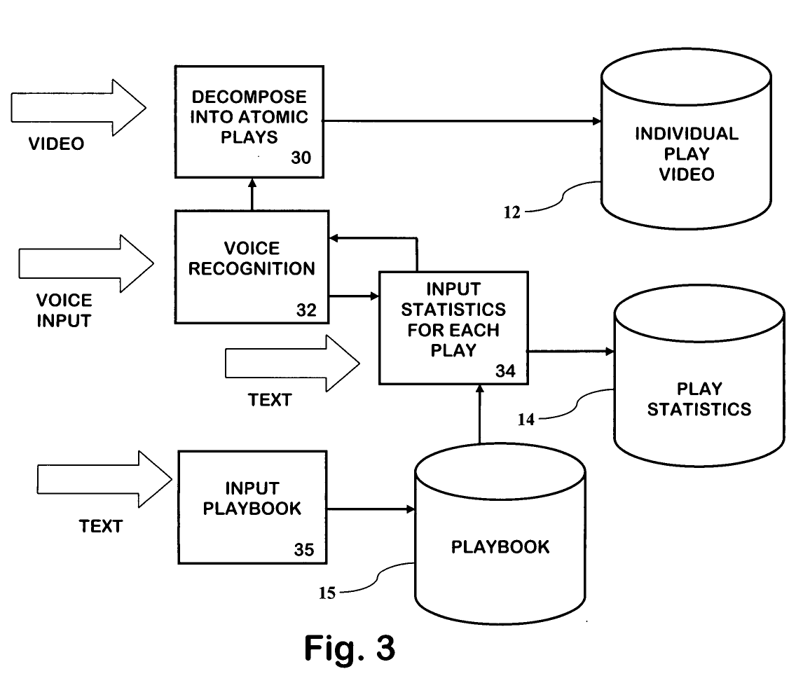

Referring now to FIG. 3, the operation of the play analysis software 10 will be further described. Before inputting information from an athletic event, a playbook 15 is established 35 by text input of various play names and players, etc. The playbook 15 then becomes a dictionary driving the input module 34 so that it accepts only valid play information.

Video from the video input 18 is decomposed into atomic plays 30 and stored in the individual play video database. In one embodiment, voice input is recognized by a voice recognition module 32 and is used to inform the play analysis software 10 as to when the play begins and ends. In another embodiment, keyboard or mouse commands are entered to indicate the beginning and end of each play. In another embodiment which is later described, time stamps from a digital video input stream are used to determine the beginning and end of each play. In another embodiment, the beginning and end of plays within the video input stream is determined by monitoring the video frames and recognizing a substantial difference between frames.

During the same session or after recording a series of video play segments, statistics for each play is entered 34 into the play statistics database 14 either by text input or by voice input through the voice recognition module 32. The input module 34 feeds the voice recognition engine 32 with a recognition vocabulary derived from the playbook 15 along with a list of allowed voice commands. The input module 34 uses the playbook 15 to help recognize valid play names.

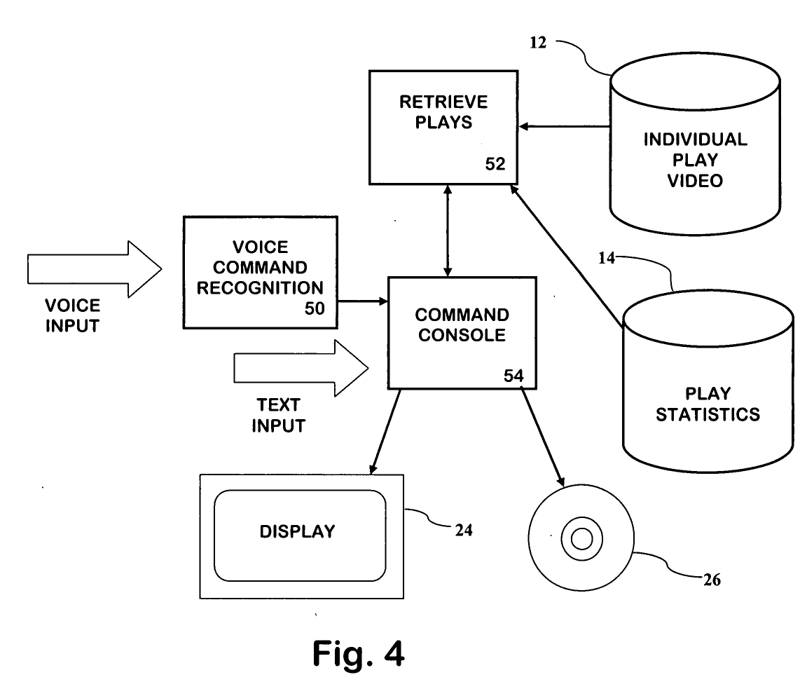

Referring now to FIG. 4, the retrieval operation of the play analysis software 10 will be further described. Voice command input is recognized by the voice command recognition module 50 or text input commands are input on the keyboard and mouse 20 and are interpreted by the command console 54. The command console 54 will request the needed play information from the individual play database 12 and the play statistics database 14 and display the information in a user interface on the display 24 or output the information to an output media 26 such as a CD, DVD disk or video tape.

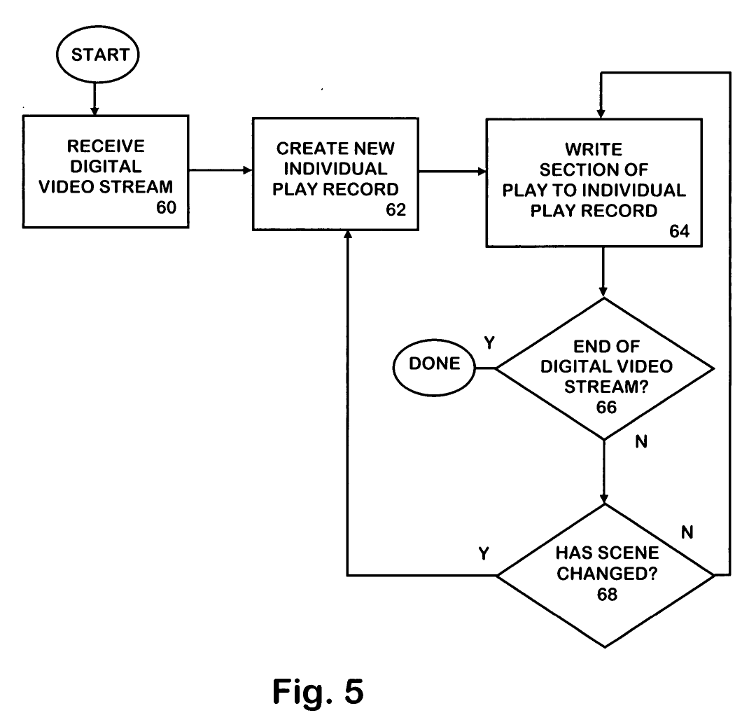

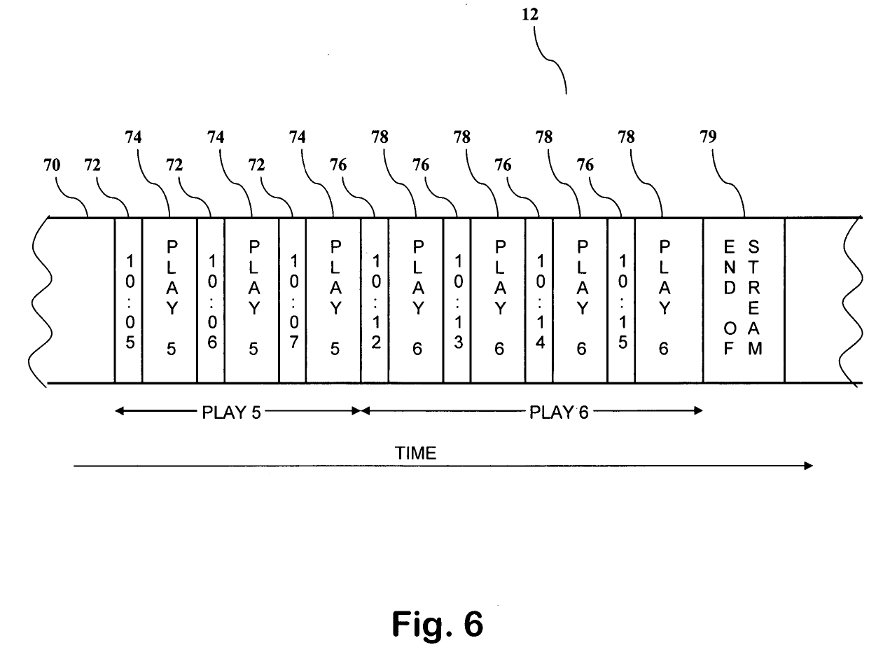

Referring now to FIG. 5, the automated method of capturing individual play video will be described. Although the play analysis software 10 works equally well with any form of video input 16, if the video input 16 is a digital video input, it is easier to divide the input stream into individual play video records. Digital video has imbedded time stamps indicating the time the video was captured. Because the videographer stops the video camera after each play, a break or gap in the sequence of time stamps occurs as seen in FIG. 6. In FIG. 6, a digital video stream 70 is depicted having time stamps 72/76 and video content of plays 74/78. In this, Play-5 (74) has three segments 74 that are time stamped 10:05, 10:06 and 10:07 (72). A second play, play-6 (78) has four segments 78 with four time stamps 10:12, 10:13, 10:14 and 10:15 (76). The break in time between the time stamps is due to the videographer stopping the recording between plays to conserve video recording media and eliminate the recording of unimportant information. Referring back to FIG. 5, this video stream is received 60 and a new individual play record is created for play-5 62 and each play-5 segment 74 is written to the individual play record 64 until either the end of the digital video stream 79 is detected 66 or a change in the scene is detected 68.

In one embodiment, the change in the scene is detected by monitoring various areas of the video frames and, when a significant change in video content from one frame to the next is detected, it is assumed that the scene has changed and a new play has begun. In another embodiment, in a digital video input stream, a significant gap or jump in the time stamp of the digital video stream is used to determine when the scene has changed. In the example of FIG. 6, after the play-5 segment 74 with time stamp 10:07 (72) is written, the next time stamp in the digital video stream is 10:21 (76), therefore a jump or gap has been detected and control flows to create another individual play record 62, repeating the steps over for each individual play. A significant gap is a time difference between time stamps that is greater than the maximum elapsed time between segments in the video stream and one second has been shown to be a good value of this test.

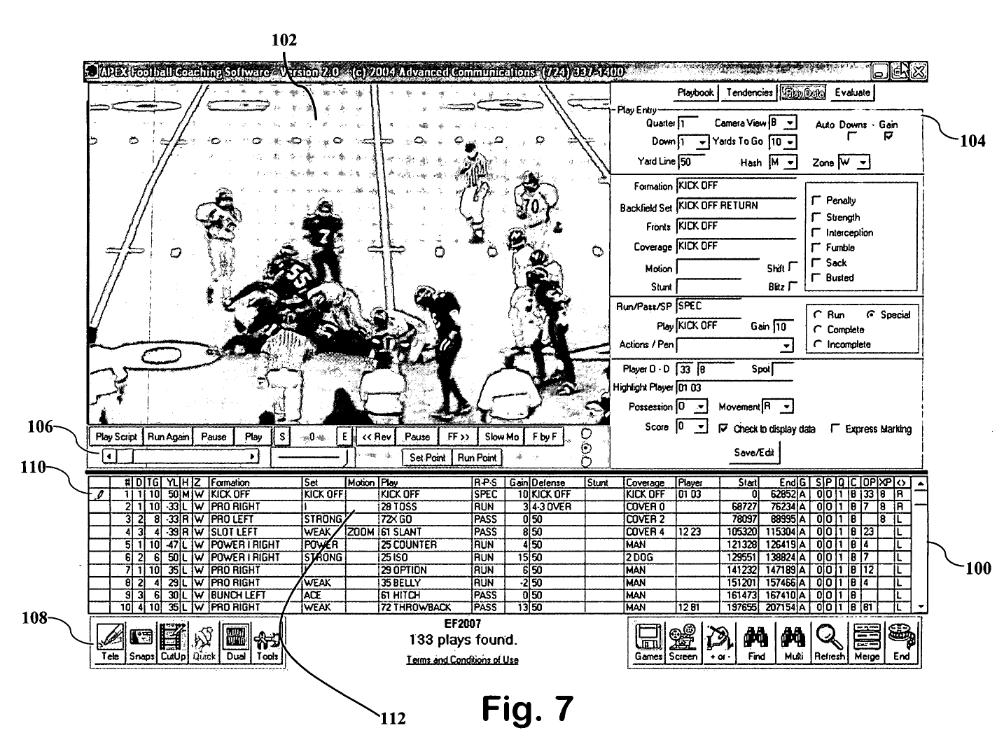

Referring now to FIG. 7, a typical user interface screen of the play analysis software 10 is shown. A video area 102 is for displaying still or motion segments of an individual play and commands and controls 106 are provided to control the playback of the video segment in the video area 102. Commands and controls 108 are also provided to initiate other actions or views. A list of individual plays are displayed in a spreadsheet format 100 with the current play indicated 110. Information regarding the current play is displayed in the upper right area 104, in this case a kick off return. Within the individual play list 100 is a second play 112 titled, “28 TOSS.” During data entry, this can be entered on the keyboard and mouse 20 or uttered into the voice input 18. Although stored in the playbook 15 as “28 toss”, a data entry person may utter the play as discrete numbers or letters, “2” “8” “T” “O” “S” “S” or “2” “8” “TOSS” or they may say it in a contiguous form “twenty eight TOSS.”

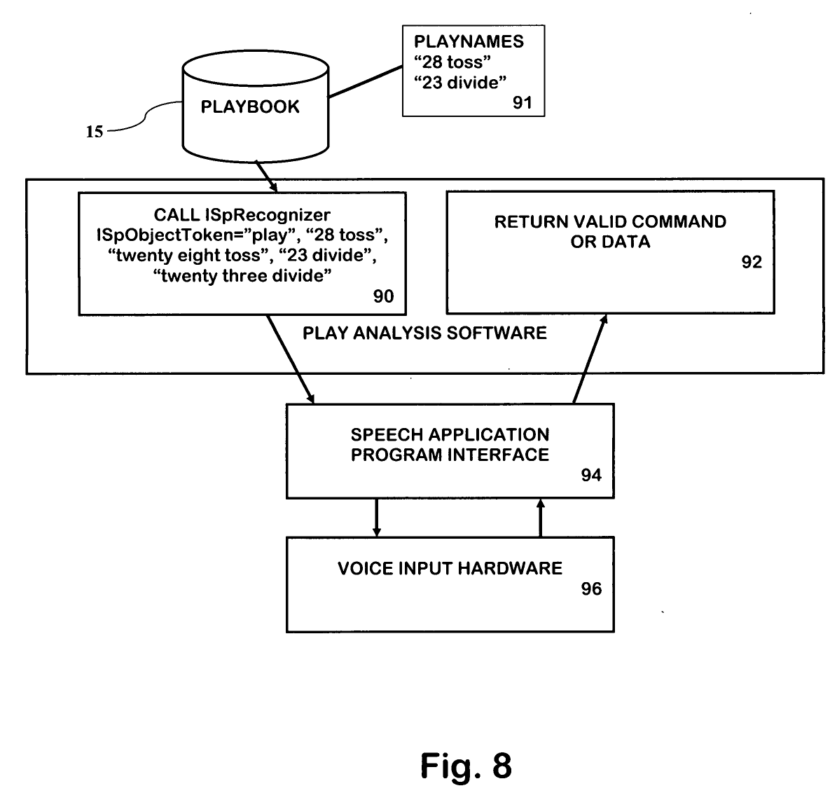

Since play analysis software 10 is built upon standard software building blocks for voice recognition, facilities were created to improve the standard voice recognition features. In general, voice recognition libraries such as Speech Application Program Interface (SAPI) version 5.1 from Microsoft takes as input a series of possible words and phrases. FIG. 8 shows how the play analysis software 10 interfaces with voice recognition software such as SAPI. A grammar and set of expected tokens is derived from the playbook 15 and supplied to the SAPI. In this simplified example, the playbook 15 contains two play names 91 “28 toss” and “23 divide”. The play analysis software detects that the plays contain numbers and creates a shadow array of play names that are passed to ISpRecognizer 90. In this example, tokens of “play”, “28 toss”, “twenty eight toss”, “23 divide” and “twenty three divide” are passed to SAPI. The Speech Application Program Interface (SAPI) 94 uses these inputs to analyze speech extracted from the voice input hardware 96 and if a recognizable command or play is decoded, the command or data is returned 92 to the play analysis software 10. In this way, even during data entry, the play analysis software 10 expects commands and acts upon them. For example, during data entry, the user can utter “play” and the return would indicate the command “play” was spoken and the play analysis software 10 would play the video segment for the current play. If the user uttered “twenty eight toss”, the return would indicate “28 toss” and that would be entered in the data entry field.

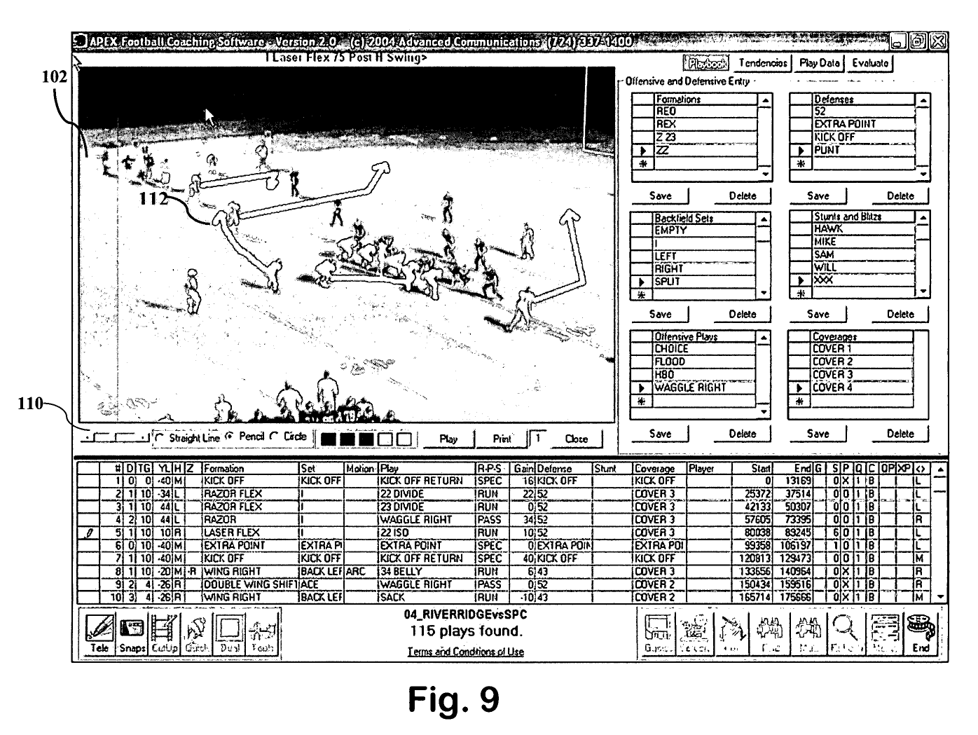

Referring now to FIG. 9, another typical user interface screen of the play analysis software 10 is shown. Similar to FIG. 7, a video area 102 is for displaying still or motion segments of an individual play. In addition, an interface 110 for creating Telestrator marks on the video is provided. Telestrator lines 112 appear on the video image 102.

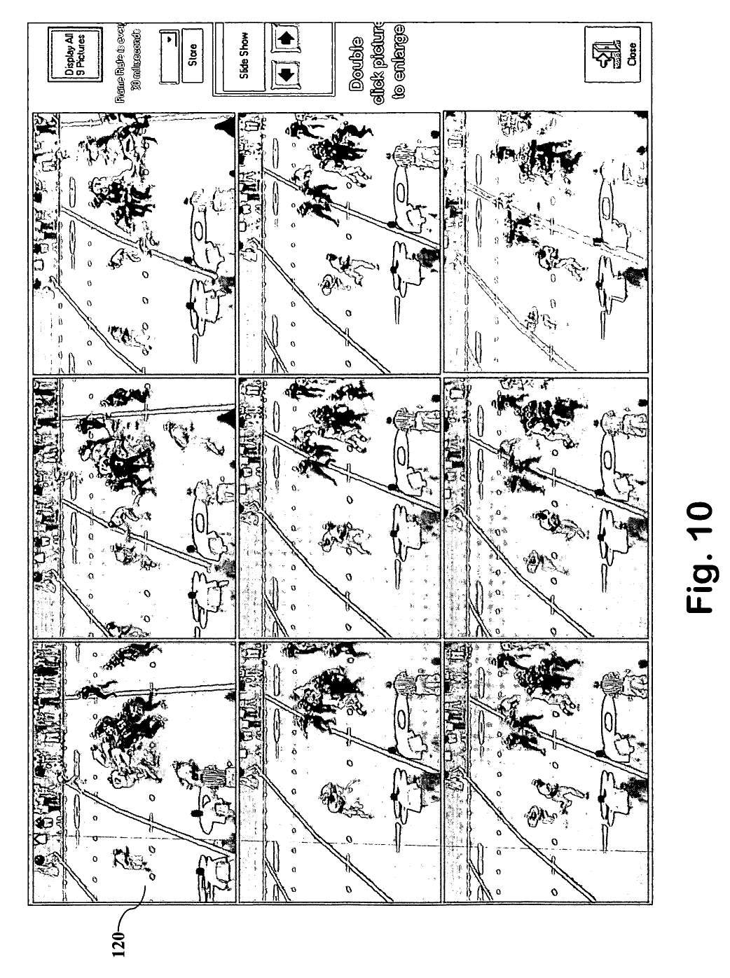

Referring now to FIG. 10, another typical user interface screen of the play analysis software 10 is shown. This interface has nine still images or snapshots 120 of a single play showing a sequence of events within the play. The rate at which the snapshots are taken is variable allowing frames to be snapped within the variable setting interval. One example of use could be the throwing motion of a quarterback. Since this motion is naturally a short time span, the snap ratio is set to 10 milliseconds, where a play such as a kick off is a much longer time frame, from the kickoff to the tackle, therefore the snap ration is set to 250 milliseconds.

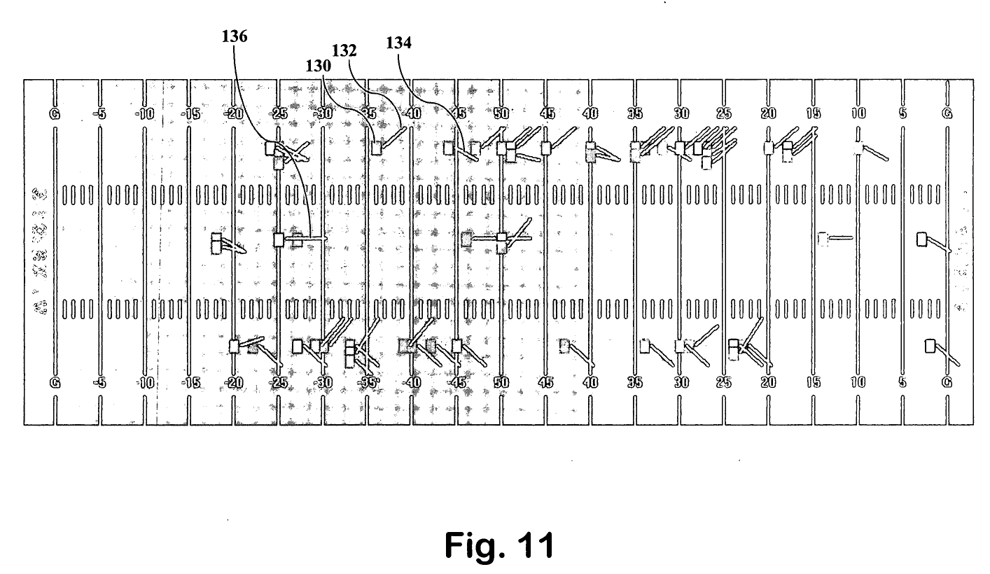

Referring now to FIG. 11, another typical user interface screen of the play analysis software 10 is shown. This interface uses data from multiple plays or all plays within an entire athletic event and graphically depicts the initial direction of movement of certain players when at different locations within the field of play. In a football game, this interface shows the initial movement of the ball carrier. In this example, each square 130 represents an individual opponent or player in an athletic event, the event being a football game. The direction of the player carrying the football is indicated by the directional line 132/134/136. This allows for a very quick visual concept of the entire game, thus allowing more accurate scouting in a much shorter time period. These directional lines provide a graphical representation of movements of various players at different locations on the field and are used to predict the movement of those players in future plays.

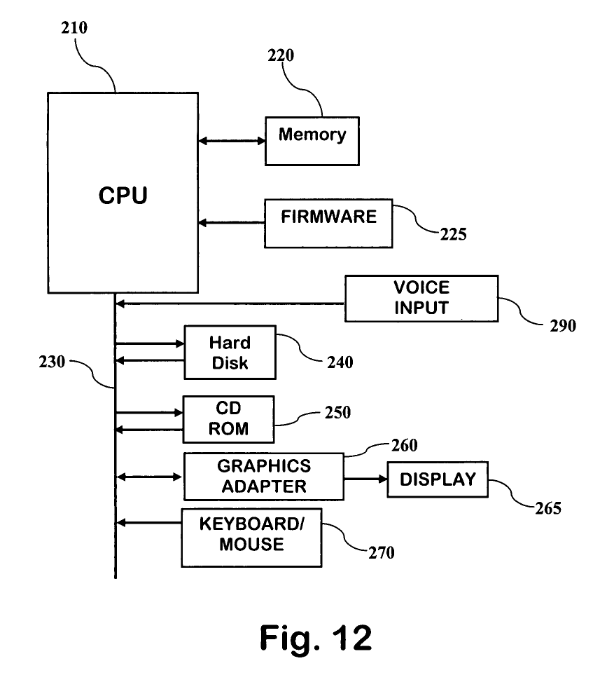

Referring to FIG. 12, a schematic block diagram of a computer-based system of the present invention is shown. In this, a processor 210 is provided to execute stored programs that are generally stored within a memory 220. The processor 210 can be any processor, perhaps an Intel Pentium-4® CPU or the like. The memory 220 is connected to the processor and can be any memory suitable for connection with the selected processor 210, such as SRAM, DRAM, SDRAM, RDRAM, DDR, DDR-2, etc. The firmware 225 is possibly a read-only memory that is connected to the processor 210 and may contain initialization software, sometimes known as BIOS. This initialization software usually operates when power is applied to the system or when the system is reset. Sometimes, the software is read and executed directly from the firmware 225. Alternately, the initialization software may be copied into the memory 220 and executed from the memory 220 to improve performance.

Also connected to the processor 210 is a system bus 230 for connecting to peripheral subsystems such as a hard disk 240, a CDROM 250, a graphics adapter 260, a voice input 290 and a keyboard/mouse 270. The graphics adapter 260 receives commands and display information from the system bus 230 and generates a display image that is displayed on the display 265.

In general, the hard disk 240 may be used to store programs, executable code and data persistently, while the CDROM 250 may be used to load said programs, executable code and data from removable media onto the hard disk 240. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, laser disk, etc. Other devices may be connected to the system through the system bus 430 or with other input-output functions. Examples of these devices include printers; mice; graphics tablets; joysticks; and communications adapters such as modems and Ethernet adapters.

In some embodiments, the voice input 290 may a microphone and a digitizer to convert speech into digital signals.

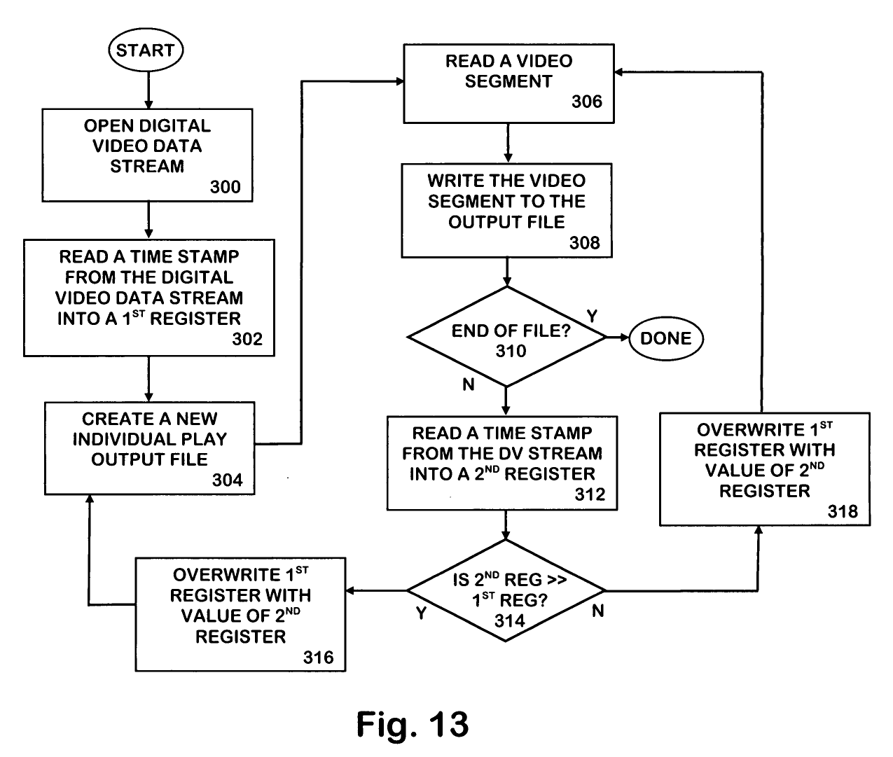

Referring now to FIG. 13, a flow chart of the video separator of the present invention is shown. In digital video data streams, each digital video segment includes a time stamp indicating the time that digital video segment was captured. The video input module of the play analysis software 10 uses this time stamp to separate the digital video data stream into individual play segments by monitoring the time stamp and looking for jumps or gaps in the play segment. The operation starts by opening the video data stream 300 and reading a time stamp into a first register 302 and creating a new individual play output file 304. Next, until either an end of the digital video data stream is reached 310 or the second time stamp differs from the first time stamp by a significant amount of time 314 called a gap time, a video segment is read 306 then written to the output file 308. The end of a segment or play is determined by reading a time stamp from the digital video (DV) stream 312 into a second register and comparing it to the previous time stamp stored in the first register 314. Normally, during sequential segments of a captured video, the difference (or gap time) will be less than a second, but if the video capture was stopped or paused, perhaps between plays, then the difference will on the order of at least one second and likely greater than 10 seconds. Therefore, if the second register is greater than the first register by the gap time 314, then it is assumed that a new play follows and the first register is over written with the value from the second register 316 to feed the next comparison and the previous steps are continued starting with creating a new individual play file 304. If there is no gap (e.g., one second), it is assumed that the next video segment is in the same play as the previous video segment and the first register is overwritten with the value from the second register 318 to feed the next comparison and flow continues by reading the next video segment 306, etc.

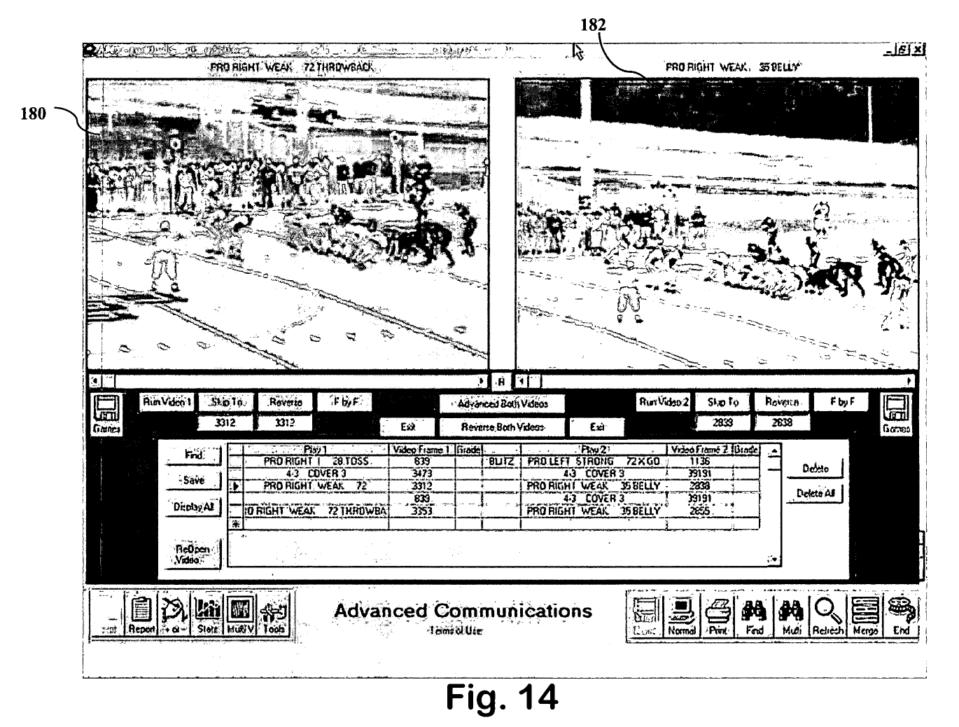

Referring now to FIG. 14, another typical user interface screen of the play analysis software 10 is shown. Similar to FIG. 7, a video area 180 is for displaying still or motion segments of an individual play. In this example, a second video area 182 is presented for comparing plays. In some cases, a successful play 180 is compared to an unsuccessful play 182.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A play analysis computer program for use in conjunction with a computer system, the play analysis computer program comprising:
a playbook for storing at least play names and player names;
an input module for accepting commands, statistics and data inputs, the input module referencing at least the play names and the player names from the playbook to validate the commands, the statistics and the data inputs;
a video input module for accepting a video input stream of an athletic event, the video input module adapted to separate the video input stream into a plurality of individual plays of the athletic event;
a user interface for displaying the individual plays and the statistics; and
a database for storing the individual plays and the statistics, whereas the input module stores the statistics in the database.

2. The play analysis computer program of claim 1, wherein the input module uses voice recognition to input the commands, the statistics and the data.

3. The play analysis computer program of claim 2, wherein the voice recognition recognizes numbers uttered as discrete digits and uttered as contiguous numbers.

4. The play analysis computer program of claim 1, wherein the video input stream is a digital video input stream having time stamps and the video input module uses changes in the time stamps to separate the video input stream into the individual plays.

5. The play analysis computer program of claim 1, wherein the video input stream is an analog video input stream and the video input module detects scene changes in the video input stream to separate the video input stream into the individual plays.

6. The play analysis computer program of claim 1, wherein the user interface is adapted to display the individual plays and the statistics on a computer display.

7. The play analysis computer program of claim 6, wherein the athletic event is a football game.

8. The play analysis computer program of claim 7, wherein the user interface includes a mode of operation whereby an initial movement of a ball carrier within the statistics is analyzed to determine the ball carrier's initial direction of movement and the ball carrier's initial direction of movement is displayed as directional lines on a playing field.

9. The play analysis computer program of claim 7, whereas the user interface includes a mode of operation whereby a first video display area and a second video display area are displayed, the first video display area having a first of the plurality of individual plays and the second video display area having a second of the plurality of individual plays.

10. A method for analyzing individual plays of a game, the method comprising:
receiving a digital video stream containing a digital video representation of an athletic event;
while more video data is present in the digital video stream:
(a) reading a time stamp from the digital video stream and storing the time stamp in a first register;
(b) creating an individual play output file for a current play of the digital video stream;
(c) reading a segment of video from the digital video stream;
(d) writing the segment of video to the individual play output file;
(e) reading a next time stamp from the digital video stream and storing the next time stamp in a second register;
(f) if the first register differs from the second register by more than a time gap, copying the contents of the second register into the first register and repeating the above steps (b) through (f); and
(g) copying the contents of the second register into the first register and repeating steps (c) through (g).

11. The method for analyzing athletic games of claim 9, wherein said time gap is one second.

12. The method for analyzing athletic games of claim 10, further comprising:
inputting statistics regarding the current play and writing the statistics into a database.

13. The method for analyzing athletic games of claim 12, further comprising:
displaying the statistics for the current play and the individual play output file for the current play in a user interface on a computer monitor.

14. The method for analyzing athletic games of claim 13, wherein the athletic event is a football game.

15. The method for analyzing athletic games of claim 14, wherein the user interface includes a mode of operation whereby an initial movement of a ball carrier within the statistics is analyzed to determine the ball carrier's initial direction of movement and the ball carrier's initial direction of movement is displayed as directional lines on a playing field.

16. The method for analyzing athletic games of claim 14, further comprising a playbook, the playbook containing at least one of play names and player names, wherein the inputting statistics includes voice recognition and the voice recognition uses the playbook to determine valid inputs.

17. The method for analyzing athletic games of claim 16, wherein numbers are stored in the playbook as discrete digits and the voice recognition includes recognizing the numbers uttered as discrete digits and uttered as contiguous numbers.

18. A machine-readable storage having stored thereon a computer program having a plurality of code sections executable by a machine for causing the machine to perform the steps of:
receiving a digital video stream containing a digital video representation of an athletic event;
while more video data is present in the digital video stream:
(a) reading a time stamp from the digital video stream and storing the time stamp in a first register;
(b) creating an individual play output file for a current play of the digital video stream;
(c) reading a segment of video from the digital video stream;
(d) writing the segment of video to the individual play output file;
(e) reading a next time stamp from the digital video stream and storing the next time stamp in a second register;
(f) if the first register differs from the second register by more than a time gap, copying the contents of the second register into the first register and repeating the above steps (b) through (f); and
(g) copying the contents of the second register into the first register and repeating steps (c) through (g).

19. The machine-readable storage of claim 18, wherein said time gap is one second.

20. The machine-readable storage of claim 18, further comprising:
inputting statistics regarding the current play and writing the statistics to a database.

21. The machine-readable storage of claim 20, further comprising:
displaying the statistics for the current play and the individual play output file for the current play in a user interface on a computer monitor.

22. The machine-readable storage of claim 21, wherein the athletic event is a football game.

23. The machine-readable storage of claim 22, wherein the user interface includes a mode of operation whereby an initial movement of a ball carrier within the statistics is analyzed to determine the ball carrier's initial direction of movement and the ball carrier's initial direction of movement is displayed as directional lines on a playing field.

24. The machine-readable storage of claim 22, further comprising a playbook, the playbook containing at least one of play names and player names, wherein the inputting statistics includes voice recognition and the voice recognition uses the playbook to determine valid inputs.

25. The machine-readable storage of claim 24, wherein numbers are stored in the playbook as discrete digits and the voice recognition includes recognizing the numbers uttered as discrete digits and uttered as contiguous numbers.
